(19) United States
(12) Patent Application Publication
(10) Pub. No.: US 2013/0139052 A1
(43) Pub. Date: May 30, 2013

(54) METHOD AND APPARATUS FOR LOADING EPUB ELECTRONIC BOOK

(71) Applicant: Huawei Technologies Co., Ltd., Shenzhen (CN)

(72) Inventors: Yaxin Rong, Shenzhen (CN); Zhi Wang, Shenzhen (CN); Shi Sun, Shenzhen (CN)

(73) Assignee: Huawei Technologies Co., Ltd., Shenzhen (CN)

(21) Appl. No.: 13/725,374

(22) Filed: Dec. 21, 2012

Related U.S. Application Data
(63) Continuation of application No. PCT/CN2012/073645, filed on Apr. 9, 2012.

(30) Foreign Application Priority Data
Nov. 26, 2011 (CN) 201110382086.5

(51) Int. Cl. G06F 17/21

(52) U.S. Cl. CPC G06F 17/217
USPC 715/251

(57) ABSTRACT

The present disclosure relates to the field of e-book technologies, and in particular, to a method and an apparatus for loading an EPub e-book into a reading device. A method for loading an EPub e-book provided herein includes: resolving a directory file of the EPub e-book to obtain directory index information of each chapter of the EPub e-book, and displaying a directory of the EPub e-book; resolving a chapter selected in the EPub e-book, and displaying content of the resolved chapter and a page number of a current page relative to the selected chapter; and obtaining number of pages of every other chapter in the EPub e-book, and displaying page number information according to the obtained number of pages of each chapter. The corresponding reading device and a system for sharing loading data of all chapters of an EPub e-book are also disclosed.

### CROSS-REFERENCE TO RELATED APPLICATIONS

This application is a continuation of International Application No. PCT/CN2012/073645, filed on Apr. 9, 2012, which claims priority to Chinese Patent Application No. 201110382086.5, filed on Nov. 26, 2011, both of which are hereby incorporated by reference in their entireties.

### FIELD

The present disclosure relates to the field of e-book technologies, and in particular, to a method and an apparatus for loading an Electronic Publication (EPub) e-book into a reading device.

### BACKGROUND

EPub is a free open e-book format standard, and is applicable on a variety of apparatuses. The standard is developed by the International Digital Publishing Forum and some important publishers. The content of the e-book may be displayed in a way most suitable for reading according to the features of the reading device. An EPub e-book is generally composed of HTML files organized in chapters. To support continuous page turning and arbitrary jumps among pages during reading, the e-book needs to be loaded into the memory for resolving first. The content of the e-book is presented to the user after the e-book is resolved.

Currently, there are two solutions to load an e-book. The first solution is to load one chapter (selected by the user) at a time, which enables fast display of the content of the chapter and generally does not go beyond the limit of the memory of the reading device. However, in such a loading mode, only the page number of the current page relative to the current chapter is displayed, and the page number of the current page relative to the entire book is not displayable. Consequently, the user can only jump among pages of the current chapter but cannot turn pages throughout the entire book flexibly, which provides much worse experience than reading a paper book.

The second solution is to load an entire e-book into the memory at a time to resolve, and the content of the current page is displayed when the destination page, namely, the page selected by the user is resolved. After the entire e-book is resolved, the page number of the current page relative to the entire book is displayable, and the user can jump and turn pages throughout the entire book flexibly. However, this solution has the following defects: before the entire book is loaded, the operations of turning pages and jumping are not supported. If the size of an EPub e-book is large, the user has to wait for a long time before the e-book is open, for example, wait for 30 seconds to 1 minute, which deteriorates the user's experience drastically.

### SUMMARY

The embodiments of the present disclosure aim to solve the problem of being unable to present page number information of an entire EPub e-book without affecting the current reading experience of the user (for example, speed of opening the e-book initially).

An embodiment of the present disclosure provides an EPub e-book loading method, which includes: resolving a directory file of an EPub e-book to obtain directory index information of each chapter of the EPub e-book, and displaying a directory of the EPub e-book; resolving a chapter selected in the EPub e-book, and displaying content of the resolved chapter and a page number of a current page relative to the chapter selected; and obtaining number of pages of every other chapter in the EPub e-book, and displaying page number information according to the obtained number of pages of the chapters.

Further, an embodiment of the present disclosure provides an EPub e-book reading device corresponding to the loading method, and the reading device includes: a resolving module, configured to resolve a directory file of an EPub e-book, and load and resolve a chapter selected in the EPub e-book; a page number obtaining module, configured to obtain number of pages of every other chapter in the EPub e-book after the resolving module loads and resolves the chapter selected in the EPub e-book; and a displaying module, configured to display a directory of the EPub e-book resolved by the resolving module, content of the chapter selected in the EPub e-book, and page number information based on the number of pages of the chapters obtained by the page number obtaining module.

An embodiment of the present disclosure provides a system for sharing loading data of each chapter of an EPub e-book, and the system includes: a reading server and a reading device. The reading server is configured to: store an EPub e-book and loading data of each chapter of the EPub e-book corresponding to the reading device; and receive an EPub e-book download request from the reading device, and send the EPub e-book and the loading data of each chapter of the EPub e-book corresponding to the reading device to the reading device. The reading device is configured to: download the EPub e-book and the loading data of each chapter of the EPub e-book corresponding to the reading device from the reading server, and load the EPub e-book according to the loading data of each chapter of the EPub e-book corresponding to the reading device.

Through the embodiments of the present disclosure, an entire EPub e-book can be loaded without affecting the current reading experience of the user, and the page number information of the entire EPub e-book is presented effectively in the loading process, which improves the reading experience of the user.

### BRIEF DESCRIPTION OF THE DRAWINGS

To describe the solutions in the embodiments of the present disclosure or in the prior art more clearly, the accompanying drawings required for describing the embodiments or the prior art are briefly introduced in the following. Apparently, the accompanying drawings in the following description are only some embodiments of the present disclosure, and persons skilled in the art may further derive other drawings according to these accompanying drawings without creative efforts.

FIG. 1 is a schematic diagram of an EPub e-book loading method according to an embodiment of the present disclosure;

FIG. 2 is a flowchart of obtaining number of pages of each chapter in an EPub e-book according to an embodiment of the present disclosure;

FIG. 3 is a flowchart of a reading device loading an EPub e-book according to an embodiment of the present disclosure;

FIG. 4 is an architecture of a solution to share loading data of chapters of an EPub e-book according to an embodiment of the present disclosure;

FIG. 5 is a flowchart of downloading an EPub e-book without corresponding chapter loading data from a reading server according to an embodiment of the present disclosure;

FIG. 6 is a flowchart of downloading an EPub e-book with corresponding chapter loading data from a reading server according to an embodiment of the present disclosure;

FIG. 7 is a schematic diagram of a reading device according to an embodiment of the present disclosure; and

FIG. 8 is a schematic diagram of a system for sharing chapter loading data of an EPub e-book according to an embodiment of the present disclosure.

### DETAILED DESCRIPTION OF THE EMBODIMENTS

The solutions in the embodiments of the present disclosure are clearly and completely described in the following with reference to the accompanying drawings in the embodiments of the present disclosure. Evidently, the drawings and the detailed description are merely representative of some particular embodiments of the present disclosure rather than all embodiments. All other embodiments, which can be derived by those skilled in the art from the embodiments given herein without making any creative effort, shall fall within the protection scope of the present disclosure.

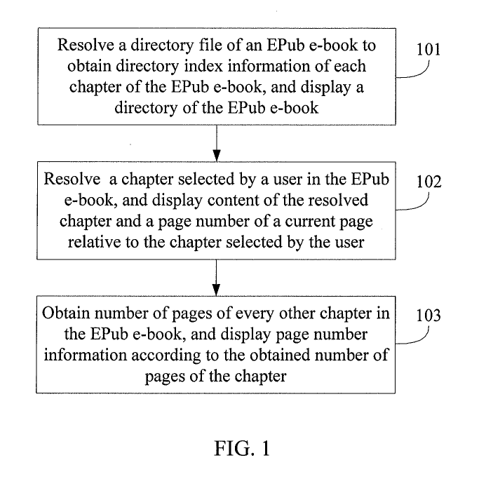

Currently, commonly used EPub e-book reading devices include but is not limited to: mobile phone, PDA, handheld reader, MP4, and tablet. An embodiment of the present disclosure provides a method for loading an EPub e-book into a reading device. The method is especially suitable for a scenario in which the memory size of a reading device is small but the e-book file size is large. As shown in FIG. 1, the method includes the following steps:

Step 101: When a user opens an EPub e-book, the reading device first resolves a navigation control file with an extension of NCX (NCX, Navigation Control file for XML) in the e-book to obtain the following information: total number of chapters of the e-book, title information of each chapter, index of each chapter in the e-book, and relative path of an XML or HTML file corresponding to each chapter in an EPub compressed package.

For ease of description, the title information of each chapter, the index of each chapter in the EPub e-book, and the relative path of an XML or HTML file corresponding to each chapter in an EPub compressed package are collectively called directory index information of each chapter, and specific name shall not be construed as limitation on the embodiments of the present disclosure.

After the directory file is resolved, the directory of the e-book is displayed to the user.

Step 102: The user accesses a chapter through the directory or a system bookmark, and the reading device reads the directory index information of this chapter first, and then loads the XML or HTML file corresponding to this chapter into memory of the reading device, resolves the XML or HTML file and displays the content of the chapter to the user, and also displays the page number of the current page relative to this chapter.

According to the page number of the current page relative to this chapter, the user can turn pages and jump to another page in this chapter flexibly. For example, the display format could be 10/100, in which 10 is a page number of the currently displayed page relative to the chapter, and 100 is the total number of pages of the chapter. By inputting the page number of a destination page, the user jumps to the destination page flexibly in the range of the 100 pages, for example, to 30/100, 57/100, 98/100 and so on.

Step 103: Obtain the number of pages of every other chapter in the EPub e-book, and display page number information according to the obtained number of pages of the chapters.

“Other chapters” refers to the chapters other than the chapter currently selected by the user for reading in the EPub e-book. In step 102 the reading device resolves the chapter selected by the user, and obtains the number of pages of the chapter. Therefore, it is not necessary to obtain the number of pages of this chapter in step 103 again.

The page number information may be displayed in an n/N format uniformly. In the foregoing format, N is the total number of pages of the loaded part, and is refreshed once the number of pages of a chapter is obtained; n is the page number of the current page relative to the entire EPub e-book. Especially, the reading device does not display n until the reading device obtains the number of pages of all chapters before the chapter selected by the user. After the background obtains the number of pages of all chapters of the entire EPub e-book, N represents the total number of pages of the entire book.

For the contents already loaded, the user can jump to another page quickly. That is, the user can jump to another page flexibly in the range of N. If the destination page to which the user jumps is in the currently displayed chapter, the chapter does not need to be reloaded, and the page selected by the user is displayed directly; if the destination page to which the user jumps is in another chapter, it is necessary to reload the chapter in which the destination page is located into the memory, and the page selected by the user is displayed to the user after completion of resolution.

The term “load” mentioned in steps 101-103 above refers to loading an XML or HTML file corresponding to a chapter of the EPub e-book into the memory of the reading device so that the reading device can resolve the file. The term “resolve” refers to typesetting the XML or HTML file loaded into the memory. The number of pages of the chapter is obtained upon completion of typesetting. Meanwhile, the reading device needs to check whether the resolved chapter is the chapter selected by the user for reading, and, if so, displays the content of the typeset chapter to the user; otherwise, the reading device does not display the content of the chapter.

The following uses an example to describe the process of displaying the page number information in step 103:

It is assumed that an EPub e-book includes 10 chapters, and each chapter has 100 pages. The user chooses to read chapter 3. The reading device loads this chapter first and resolves it, and displays the content of the chapter to the user upon completion of resolution. Upon completion of displaying the content of chapter 3, the reading device starts obtaining the number of pages of each chapter other than chapter 3 in the e-book in the background. For example, after obtaining the number of pages of chapter 1, the reading device refreshes the displayed page number to n/100; after obtaining the number of pages of chapter 2, the reading device refreshes the displayed page number to n/200; after obtaining the number of pages of chapter 2, because chapter 3 has been resolved previously and the number of pages of chapter 3 has been obtained, the reading device can refresh the page number of the current page relative to the loaded part, for example, to 205/300. Afterward, once the number of pages of a chapter is obtained, the reading device refreshes the total number of pages of the loaded part, for example, to 205/400, 205/700, and so on.

For the part already loaded, the user can jump to another page quickly. That is, the user can jump to another page quickly in the range of the first 200 pages, first 300 pages, or first 700 pages, for example, jump to 137/200, 270/300, or 501/700, and so on. After the number of pages of the last chapter of the e-book is obtained, the displayed page number is updated to 205/1000. At this time, the user can turn pages flexibly throughout the entire book.

Through the solution disclosed in this embodiment, the displayed page number information is updated according to the progress of obtaining the number of pages of each chapter of the EPub e-book in the background. Therefore, the user can clearly perceive the progress of loading the EPub e-book in the background, and can jump to another page flexibly in the range of the loaded part or even the entire e-book, which optimizes the reading experience of the user.

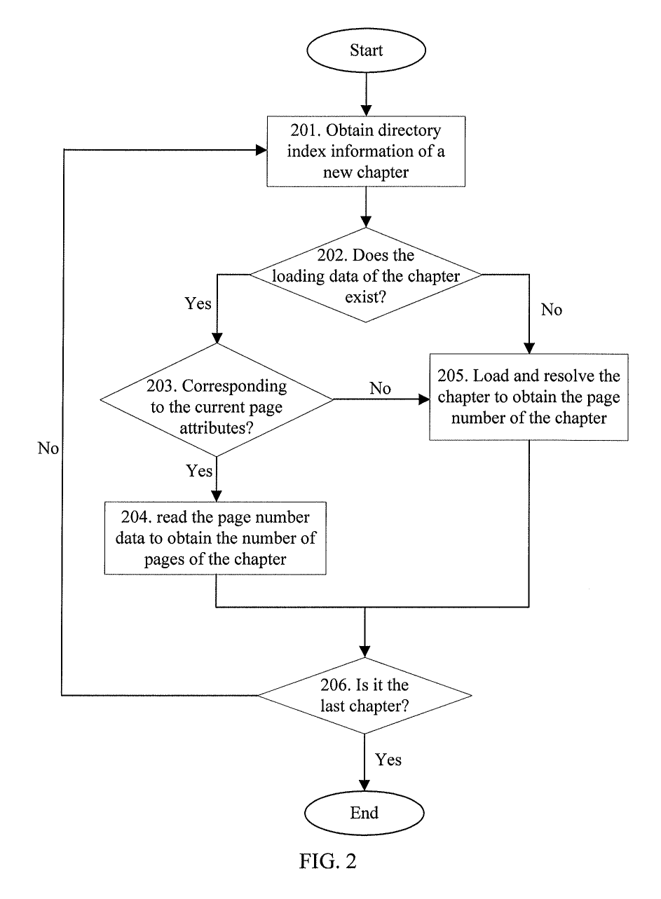

FIG. 2 shows a detailed procedure of obtaining number of pages of every other chapter in an EPub e-book according to step 103. According to step 103 above, at the time of obtaining the number of pages of the chapter selected by the user for reading, the number of pages of the chapter obtained in step 102 is directly applicable, and does not need to be obtained in this procedure again.

The detailed steps are as follows:

Step 201: The reading device obtains directory index information of a chapter in an e-book.

Step 202: According to the directory index information of the chapter, the reading device checks whether the loading data of the chapter is stored in the reading device. If the loading data of the chapter is stored in the reading device, go to step 203; otherwise, go to step 205.

The loading data of the chapter includes an identifier that uniquely identifies the EPub e-book, directory index information of the chapter, number of pages of the chapter, and page attribute information effective at the time of resolving the chapter.

Step 203: Check whether the page attribute information in the loading data of the chapter corresponds to the page attribute of the currently displayed page. If so, go to step 204; if not, go to step 205.

The number of pages of the chapter, which is obtained by the reading device through resolving a chapter file of the EPub e-book, strongly depends on the page attributes such as font, font size, resolution, and page size selected by the user. Therefore, after finding that the loading data of the chapter is stored in the reading device, the reading device needs to check whether the page attribute information in the loading data of the chapter corresponds to the page attribute selected currently by the user. If so, the reading device may read the number of pages of the chapter directly; if not, the reading device needs to resolve again to obtain the number of pages of the chapter under the current page attributes.

Step 204: Read the loading data of the chapter to obtain the number of pages of the chapter. Go to step 206.

Step 205: Load an XML or HTML file corresponding to the chapter into the memory, and resolve the file to obtain the number of pages of the chapter.

According to steps 201-204 above, if the reading device does not store the chapter loading data of the EPub e-book corresponding to the current page attributes, the reading device needs to load the chapter and obtain the number of pages of the chapter through resolving.

To avoid occupying the memory of the reading device excessively, once the number of pages of a chapter is obtained, the reading device deletes the loaded XML or HTML file in the memory which is corresponding to the chapter, and stores only the obtained number of pages of the chapter. In this case, only the data of the chapter which is being read by the user is stored in the memory. In another case, the memory not only stores the data of the chapter which is being read by the user, but also stores the data of a previous chapter and the data of a next chapter. In this way, the reading device can display the content of the current chapter and the content of the next chapter simultaneously when the user turns from the last page of the current chapter to the next page; and the reading device can display the content of the current chapter and the content of the previous chapter simultaneously when the user turns from the first page of the current chapter to the previous page, which gives an experience closer to the experience of reading a paper book.

Step 206: Check whether the chapter is the last chapter of the EPub e-book. If so, the procedure is finished; if not, return to step 201 to obtain the number of pages of the next chapter.

In step 205, at the time of storing the number of pages of the chapter that is obtained through resolving, the identifier that uniquely identifies the EPub e-book, directory index information of the chapter, number of pages of the chapter, and page attribute information effective at the time of loading the chapter are stored uniformly in this embodiment of the present disclosure. The identifier that uniquely identifies the EPub e-book refers to an identifier that differentiates the EPub e-book from other EPub e-books; the directory index information of the chapter includes chapter title information, an index of the chapter in the e-book, and a relative path of the chapter file in the EPub compressed package.

For ease of description, the information stored uniformly mentioned above may be called as loading data of the chapter. The way to name the information should not be construed as limitation on the present disclosure.

For a chapter selected by the user for reading, the number of pages of the chapter has been obtained through resolving in step 102, and therefore, the loading data of the chapter selected by the user can be generated upon completion of step 102.

To ensure the stored data accurately describe the obtained data after the content of a chapter is loaded into a specific terminal device, a storage field is provided in this embodiment:

public class PageCountItem
{

/**
* current book id: an identifier that identifies the book
uniquely
*/
public String bookId;
/**
* the index of chapter in the book: index of the chapter in the
entire book
*/
public int chapterIndex;
/**
* the url of catalog content file: relative path of the chapter
file in the EPub

compressed package

*/
public String chapterUrl;

/**
* the page size, that need to load: page size at the time
of text typesetting
*/
public String pageSize;
/**
* current font size: font size at the time of text
typesetting
*/
public int fontSize;
/**
* current chapter page count: number of pages of the
current chapter on the device
*/
public int pageCount;

}

Evidently, in the procedure of obtaining the number of pages of each chapter of the EPub e-book in foregoing embodiments, two steps of checking are included: at first, checking whether the reading device stores the chapter loading data of the EPub e-book; then, further checking whether the page attribute information in the chapter loading data matches the page attribute information of the current page. Nevertheless, it is also appropriate to load chapters directly one by one and resolve them without checking whether the reading device stores the loading data of each chapter in the EPub e-book; or, only to check whether the reading device stores the loading data of each chapter and read the number of pages of each chapter directly without checking whether the page attribute information matches. The steps of checking are not limited in the embodiments of the present disclosure.

In embodiments of the present disclosure, only the chapter selected by the user is loaded into the memory of the reading device at first, and the content of this chapter can be resolved quickly and displayed to the user so that the user does not need to wait for a long time. When obtaining the total number of pages of the EPub e-book, the solution in the embodiments of the present disclosure does not load the entire e-book into the memory at a time, but loads one chapter at a time. After the number of pages of the chapter is obtained through resolving, the chapter file loaded in the memory is deleted, and only the number of pages of the chapter is retained before the loading of the next chapter begins. In this way, the page number of the current page relative to the entire EPub e-book is obtained, and the user can jump to another page flexibly throughout the entire book. Moreover, this method avoids disruption of normal reading of the user, which occurs when the memory space occupied by loading the entire EPub e-book at a time exceeds the memory limit allocated to the reading process.

Further, the method in embodiments of the present disclosure improves the loading efficiency by checking whether the reading device stores the loading data of the chapter to be resolved, and improves the loading accuracy by matching the page attribute information.

With reference to the solution in the foregoing embodiments, the following embodiment describes a process of a reading device loads an EPub e-book when a user opens the EPub e-book.

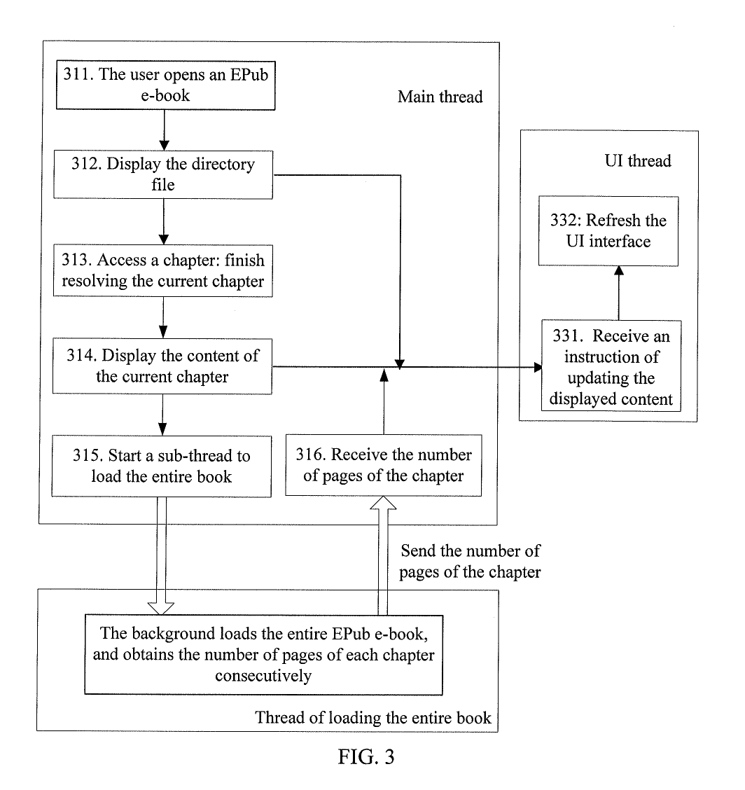

As shown in FIG. 3, an EPub e-book loading procedure provided in the solution according to embodiments of the present disclosure may include three threads: main thread, thread of loading the entire book, and UI (user interface) thread. The following describes the steps of interaction within and between the three threads consecutively.

Steps of the main thread:

Step 311: The user opens an EPub e-book, and the reading device starts the main thread.

Step 312: The reading device resolves a directory file with an extension of NCX in the e-book, sends a notification to the UI thread to display the resolved e-book directory.

Step 313: The user accesses a chapter of the e-book through the directory, and the reading device loads the chapter selected by the user and resolves it.

Step 314: Send a notification to the UI thread as an instruction of refreshing the current page, and display the content of the resolved chapter and the page number of the current page relative to the current chapter.

Step 315: Instruct the background to start a sub-thread to load the entire EPub e-book, obtain the number of pages of each chapter other than the chapter selected by the user for reading, and proceed to the thread of loading the entire book in the background.

Step 316: Receive the number of pages of every other chapter in the EPub e-book, which is obtained by the background; and instruct the UI thread to refresh page number information.

Steps of the thread of loading the entire book at the background:

The main thread resolves the chapter selected by the user, and instructs the UI thread to display the content of the resolved chapter, and then instructs the background to start the thread of loading the entire book.

The detailed description of FIG. 2 in the preceding embodiment has given thorough description of the procedure of loading an entire EPub e-book in the background and obtaining the number of pages of each chapter consecutively, and the procedure is not repeated here any further.

Once the number of pages of a chapter is obtained in the background, it is fed back to the main thread. The main thread instructs the UI thread to refresh the displayed page number information, including: total number of pages of each chapter, and the page number of the current page relative to the entire EPub e-book.

Steps of the UI thread:

Step 331: Receive an instruction of updating the displayed content from the main thread.

Step 332: Refresh the UI interface to update the displayed content.

As mentioned above, when the reading device resolves the content of a chapter selected by the user in the EPub e-book and obtains the number of pages of each chapter of the e-book, the number of pages of the chapter strongly depends on the page attributes such as font size, resolution, and page size selected by the user. The font size may be controlled through font scaling, and the switching between the landscape screen and the portrait screen and the resolution adjustment lead to change of the page size.

In the process of loading the EPub e-book based on the solution of the present disclosure, the loading process changes once the user adjusts the page attributes.

After the user adjusts the page attributes, the reading device needs to terminate the background process first. After resolving and displaying the content of the chapter selected by the user under the new page attributes again, the reading device resumes the process of loading the entire book. The reading device obtains the number of pages of each chapter under the new page attributes in the EPub e-book consecutively in the background, and displays the page number information under the new page attributes again.

When an EPub e-book is loaded through the procedure disclosed in this embodiment, the three threads collaborate with each other to quickly display the content of the chapter selected by the user to the user, and obtain the page number information of the entire e-book, which meets the user's requirement of jumping to another page flexibly. Because only one chapter is loaded to resolve at a time, the page number of each chapter in the e-book can be obtained at the cost of occupying a very small space of the memory. Meanwhile, in the solution disclosed herein, the loading solution changes when the user adjusts the page attributes, so as to quickly adapt to the user's operation of adjusting attributes.

Currently, the function of accessing the Internet is generally available on the user's EPub e-book reading device such as mobile phone, PDA, handheld reader, MP4, tablet computer, and so on. Downloading an EPub e-book from a reading server to a local reading device to read has become a very popular mode of reading e-books. The reading server refers to a network server capable of storing EPub e-books and the loading data of each chapter of the e-books, and providing the corresponding download service.

With reference to the solution and reading server disclosed in the preceding embodiments, the following embodiment of the present disclosure discloses a network sharing solution for sharing chapter loading data of an EPub e-book. The chapter loading data of the EPub e-book is a collective term of information, including: an identifier that uniquely identifies the EPub e-book, directory index information of the chapter, page attribute information effective at the time of loading the chapter, and number of pages of the chapter, which are stored after the reading device obtains the number of pages of one chapter.

As shown in FIG. 4, user A downloads an EPub e-book from a reading server. When the user opens the e-book initially, all chapters of the e-book are loaded completely, and the loading data of each chapter is generated and stored locally.

User A may choose to upload the loading data of each chapter of the EPub e-book to the reading server. As the loading data is generated on the specific reading device, when uploading the loading data, user A needs to upload the attribute information as well, such as type and model of the reading device of user A, and so on. The reading server stores the loading data of each chapter of the EPub e-book according to the attribute information of the reading device.

It is assumed that user B and user A use the same type of e-book reading device. When downloading the same EPub e-book, user B can obtain the loading data of each chapter of the e-book at the same time. In this way, when user B reads the e-book, if the page attributes remain unchanged, the reading device can read the loading data of each chapter of the EPub e-book directly, and obtain the number of pages of each chapter quickly, so as to display the page number of the current page relative to the entire EPub e-book, and the number of pages of the entire EPub e-book.

If user B changes the page attributes, the reading device stores the loading data of each chapter under the new page attributes while resolving each chapter of the EPub e-book and obtaining the number of pages of each chapter. User B may also choose to upload the newly stored loading data of each chapter to the reading server.

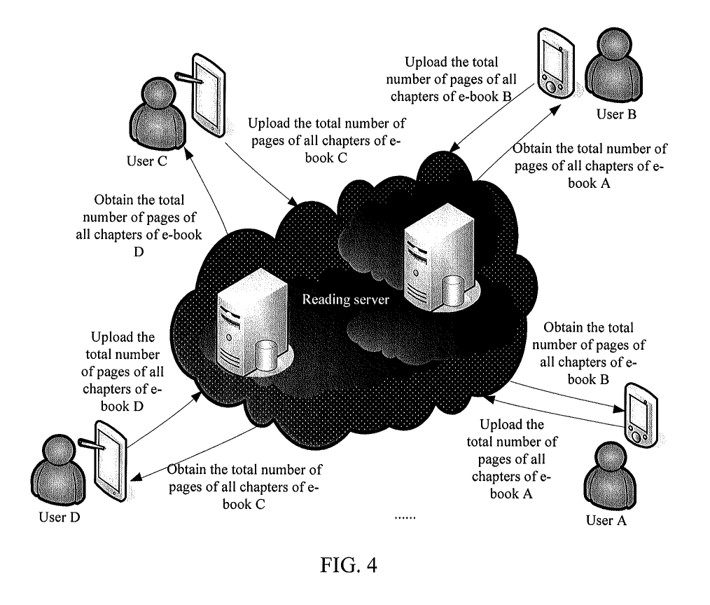

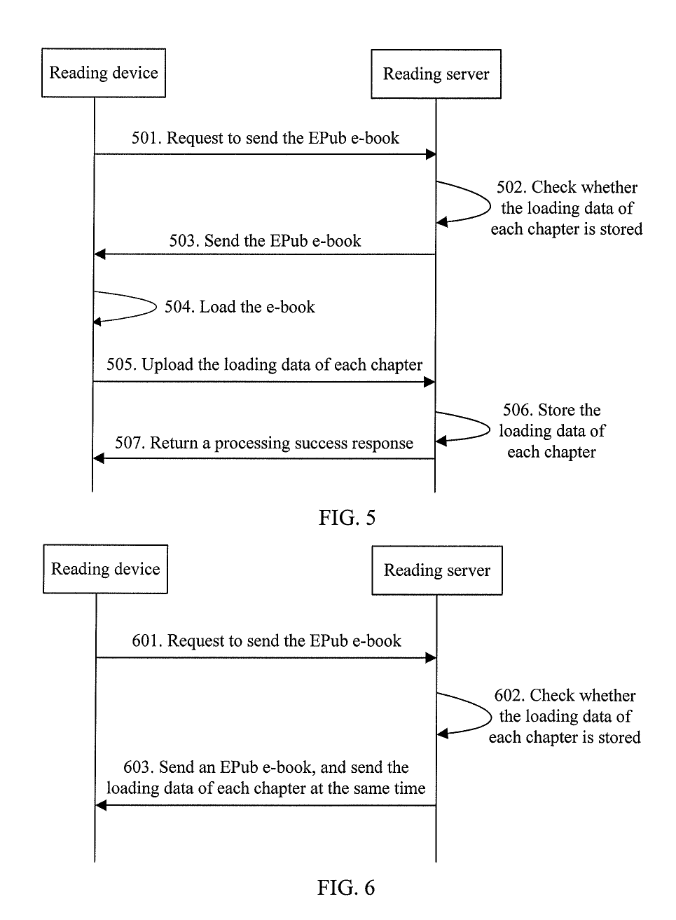

As shown in FIG. 5, a user downloads an EPub e-book that lacks chapter loading data from a reading server, and the downloading steps are as follows:

Step 501: The user sends a request to the reading server to request downloading of an EPub e-book. The request carries attribute information of the reading device of the user.

Step 502: The reading server authenticates the user's request, and checks whether the loading data of each chapter of the EPub e-book corresponding to the reading device of the user is stored.

Step 503: If no loading data of each chapter of the EPub e-book is stored, the reading server sends only the EPub e-book to the user.

Step 504: The user receives the EPub e-book. When the user opens the e-book, the loading data of each chapter is generated according to the method disclosed in the embodiments of the present disclosure.

Step 505: The user uploads the locally generated loading data of each chapter of the EPub e-book and the attribute information of the reading device to the reading server.

Step 506: The reading server stores the loading data of each chapter of the EPub e-book.

Step 507: The reading server sends a processing success response to the user.

As shown in FIG. 6, the steps of a user obtains an EPub e-book with loading data of each chapter from a reading server are described in the following:

Step 601: The user sends a request to the reading server to request downloading of an EPub e-book. The request carries attribute information of the reading device of the user.

Step 602: The reading server authenticates the user's request, and checks whether the loading data of each chapter of the EPub e-book corresponding to the reading device of the user is stored.

Step 603: If the loading data of each chapter of the EPub e-book is stored, the reading server sends the EPub e-book to the user, and sends the loading data of each chapter of the e-book at the same time.

The reading device of user works together with the reading server, once the loading data of each chapter of the EPub e-book corresponding to a specific reading device, which is uploaded by a user, is stored in the reading server, all users using the same reading device can share the loading data of each chapter of the EPub e-book. When reading the EPub e-book, the reading device can read the loading data of each chapter under the corresponding page attributes directly, and obtain the number of pages of each chapter quickly, so as to display the page number of the current page relative to the entire EPub e-book and the number of pages of the entire EPub e-book.

Corresponding to the EPub e-book loading method disclosed in the preceding embodiments, a reading device is provided in an embodiment of the present disclosure to implement the method. The reading device refers to a device capable of reading EPub e-books, including but without being limited to mobile phone, PDA, handheld reader, MP4, tablet, notebook, and desktop computer.

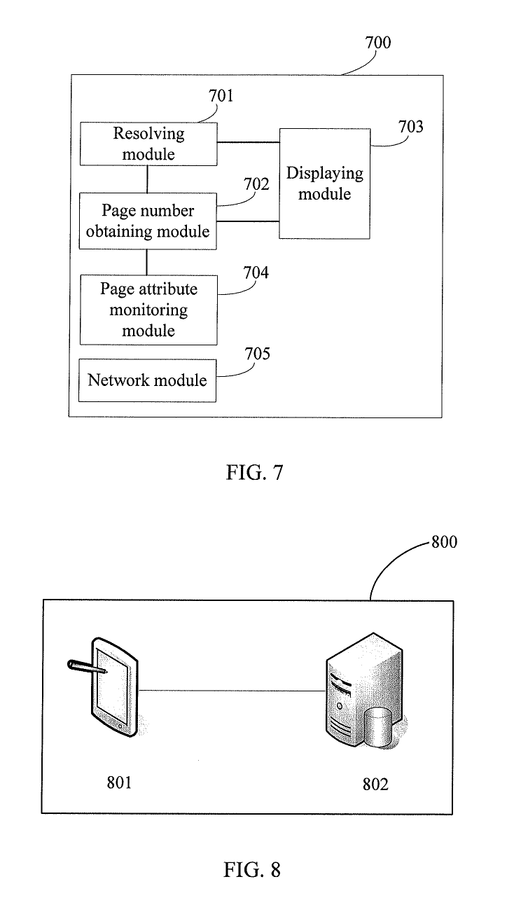

As shown in FIG. 7, the reading device 700 includes a resolving module 701, a page number obtaining module 702, and a displaying module 703.

The resolving module 701 is configured to resolve the directory file of the EPub e-book to obtain the number of chapters of the EPub e-book and directory index information of each chapter, instruct the displaying module 703 to display the directory file of the e-book, load and resolve the chapter selected by the user, and instruct the displaying module 703 to display the content of the chapter.

The directory index information of each chapter includes chapter title information of each chapter, an index of each chapter in the e-book, and a relative path of each chapter file in the EPub compressed package.

The page number obtaining module 702 is configured to obtain number of pages of every other chapter in the EPub e-book after the resolving module 701 loads and resolves the chapter selected by the user in the EPub e-book.

The displaying module 703 is configured to display a directory of the EPub e-book resolved by the resolving module 701, content of the chapter selected by the user, and the page number of the current page relative to the chapter selected by the user; and display the total number of pages of each chapter in the EPub e-book and the page number of the current page relative to the entire EPub e-book, where the total number of pages and the page number of the current page are obtained by the page number obtaining module 702, namely, display the page number information according to the number of pages of every other chapter obtained by the page number obtaining module 702.

The page number obtaining module 702 is further configured to generate the loading data of each chapter in the EPub e-book out of the obtained number of pages of each chapter in the EPub e-book, and store the loading data in the reading device.

The loading data of each chapter of the EPub e-book includes an identifier that uniquely identifies the EPub e-book, directory index information of each chapter, the obtained number of pages of each chapter, and page attribute information effective at the time of loading each chapter.

The reading device 700 provided in this embodiment may further include:

a page attribute monitoring module 704, configured to: check whether page attribute of the EPub e-book changes; if the page attribute changes, instruct the resolving module 701 to resolve the chapter selected by the user again, and instruct the page number obtaining module 702 to obtain the number of pages of every other chapter in the EPub e-book again; and

The network module 705 is configured to exchange information between the reading device and the reading server, including: generate attribute information of the reading device, send a request that carries the attribute information of the reading device to the reading server to transmit EPub e-book data, receive the EPub e-book data sent by the reading server, and send the loading data of each chapter of the EPub e-book to the reading server.

The attribute information of the reading device includes type and model of the reading device, and is used by the reading server to store the loading data of each chapter of the EPub e-book corresponding to a specific reading device. When a request for transmitting the EPub e-book data is received, the attribute information of the reading device is also used to identify the type and the model of the reading device that sends the request.

Further, an embodiment of the present disclosure provides a system for sharing loading data of each chapter of an EPub e-book. As shown in FIG. 8, the system 800 for sharing the chapter loading data includes a reading device 801 and a reading server 802.

The reading device 801 is configured to: download the EPub e-book and the loading data of each chapter of the EPub e-book corresponding to the reading device 801 from the reading server 802, and load the EPub e-book according to the loading data of each chapter of the EPub e-book corresponding to the reading device 801.

The loading data of each chapter of the EPub e-book is a collective term of information including: an identifier that uniquely identifies the EPub e-book, directory index information of the chapter, page attribute information effective at the time of resolving the chapter, and number of pages of the chapter, which are stored after the reading device obtains the number of pages of one chapter.

The reading device 802 is configured to: store the EPub e-book and the loading data of each chapter of the EPub e-book corresponding to the reading device 801; receive an EPub e-book download request from the reading device 801, and send the EPub e-book and the loading data of each chapter of the EPub e-book corresponding to the reading device 801 to the reading device 801.

Through the data sharing system disclosed in this embodiment, plenty of loading data of each chapter of the EPub e-book is stored on the reading server 802. The user can obtain the loading data of each chapter related to the reading device 801 while downloading the EPub e-book, and can read the number of pages of each chapter quickly and display the page number of the current page relative to the entire EPub e-book.

It can be known through the description of the foregoing embodiments, persons skilled in the art can clearly know that all or a part of steps of the method in the foregoing embodiments may be implemented by using a manner of software in combination with a necessary general hardware platform including a hardware processor. Based on such understanding, the essence of the solutions of the present disclosure or a part of the solutions that make contributions to the prior art may be embodied in a form of a software product. The software product of the computer may be stored in a storage medium accessible to the hardware processor, for example, a ROM/RAM, a magnetic disk, or a compact disk, and includes a number of instructions which are used to enable a computer device (which may be a personal computer, a server, or a network device) to execute the methods described in each embodiment or in some part of the embodiments of the present disclosure.

It should be noted that in the specification, each embodiment is described by adopting a progressive manner. The same and similar parts between each embodiment may be cross-referenced, and each embodiment focuses a difference between the embodiment and other embodiments. Particularly, the apparatus embodiments are described rather briefly due to its similarity to the method embodiments basically. For the execution process of specific functions of each unit, reference may be made to some descriptions of the method embodiments. The foregoing-described apparatus embodiments are merely schematic, where the units described as separate components may be or may not be physically independent of each other. The components displayed as units may be or may not be a physical unit, which can be either located at a position or may be distributed on multiple network units. A part of or all of the modules among them may be selected according to actual requirements so as to implement the objectives of the solutions of the embodiments. Persons skilled in the art may understand and implement the embodiments without any creative effort.

In conclusion, the foregoing descriptions are only exemplary embodiments of the solutions of the present disclosure and are not intended to limit the protection scope of the present disclosure. Any modification, equivalent replacement, or improvement made within the spirit and principle of the present disclosure shall fall within the protection scope of the present disclosure.

What is claimed is:

1. A method for loading an Electronic Publication (EPub) e-book, comprising:
resolving a directory file of the EPub e-book to obtain directory index information of each chapter of the EPub e-book, and displaying a directory of the EPub e-book;
resolving a chapter selected in the EPub e-book, displaying content of the resolved chapter, and obtaining a page number of a current page relative to the chapter selected; and
obtaining number of pages of every other chapter in the EPub e-book, and displaying page number information according to the obtained number of pages of each chapter.

2. The method according to claim 1, wherein the obtaining the number of pages of every other chapter in the EPub e-book, and the displaying page number information according to the obtained number of pages of each chapter comprises:
displaying, a total number of pages of all chapters according to the obtained number of pages of each chapter;
displaying page number of a current page relative to the entire EPub e-book after obtaining number of pages of all chapters before the chapter selected.

3. The method according to claim 1, wherein obtaining the number of pages of every other chapter in the EPub e-book comprises:
obtaining directory index information of a chapter in the EPub e-book;
checking whether loading data of the chapter is already stored in a current reading device according to the directory index information of the chapter;
if the loading data of the chapter is already stored in the current reading device, reading the loading data of the chapter, and obtaining the number of pages of the chapter;
if the loading data of the chapter is not stored in the current reading device, loading and resolving the chapter, and obtaining the number of pages of the chapter.

4. The method according to claim 3, wherein if the loading data of the chapter is already stored in the current reading device, reading the loading data of the chapter, and obtaining the number of pages of the chapter, comprises:
checking whether page attribute information corresponding to the loading data of the chapter matches page attribute information of a current page, and reading the loading data of the chapter to obtain the number of pages of the chapter if the matching succeeds;
if the page attribute information corresponding to the loading data of the chapter does not match the page attribute information of the current page, loading and resolving the chapter, and obtaining the number of pages of the chapter.

5. The method according to claim 3, wherein after loading the chapter to resolve and obtaining the number of pages of the chapter, generating the loading data of the chapter and storing the loading data in the current reading device, and deleting the loaded chapter from a memory.

6. The method according to claim 5, wherein after storing the loading data of the chapter in the current reading device, uploading the loading data of the chapter to a reading server.

7. The method according to claim 5, wherein the loading data of the chapter comprises an identifier of the EPub e-book, directory index information of the chapter, number of pages of the chapter, and page attribute information effective at time of resolving the chapter.

8. The method according to claim 1, further comprising:
when the page attribute information of the current page changes, resolving the chapter selected in the EPub e-book again, and displaying content resolved again; and
obtaining the number of pages of every other chapter in the EPub e-book again, and displaying the page number information according to the number of pages of the chapter that is obtained again.

9. The method according to claim 8, wherein the page attribute information comprises at least one of the following items: font, font size, resolution, or page size.

10. A reading device having a processor and a non-transitory storage medium accessible to the processor, wherein the reading device comprises:
a resolving module, configured to resolve, by the processor, a directory file of an Electronic Publication (EPub) e-book, and load and resolve a chapter selected in the EPub e-book;
a page number obtaining module, configured to obtain, by the processor, number of pages of every other chapter in the EPub e-book after the resolving module loads and resolves the chapter selected in the EPub e-book; and
a displaying module, configured to display a directory of the EPub e-book resolved by the resolving module, content of the chapter selected in the EPub e-book, and page number information based on the number of pages of the chapter obtained by the page number obtaining module.

11. The reading device according to claim 10, wherein the reading device further comprises:
a page attribute monitoring module, configured to check whether a page attribute of a current page in the EPub e-book changes; and
if the page attribute of the current page changes, instructing the resolving module to load and resolve the chapter selected in the EPub e-book again.

12. The reading device according to claim 10, wherein the page number obtaining module is further configured to generate the loading data of each chapter in the EPub e-book out of the obtained number of pages of each chapter in the EPub e-book, and store the loading data in the reading device.

13. The reading device according to claim 10, wherein the displaying module is further configured to:
according to the number of pages of each chapter obtained by the page number obtaining module, display a total number of pages of all chapters and the page number of the current page relative to the entire EPub e-book.

14. The reading device according to claim 10, wherein the reading device further comprises:
a network module, configured to communicate with a reading server, generate attribute information of the reading device, send a request for downloading the EPub e-book that carries the attribute information of the reading device to the reading server, receive the EPub e-book sent by the reading server, and send the loading data of each chapter of the EPub e-book corresponding to the reading device to the reading server.

15. A system for sharing loading data of each chapter of an Electronic Publication (EPub) e-book, comprising a reading server and a reading device, wherein:
the reading server is configured to: store the EPub e-book and the loading data of each chapter of the EPub e-book corresponding to the reading device; receive an EPub e-book download request from the reading device, and send the EPub e-book and the loading data of each chapter of the EPub e-book corresponding to the reading device to the reading device; and
the reading device is configured to: download the EPub e-book and the loading data of each chapter of the EPub e-book corresponding to the reading device from the reading server, and load the EPub e-book according to the loading data of each chapter of the EPub e-book corresponding to the reading device.

16. The system according to claim 15, wherein the reading device is further configured to:
generate the loading data of each chapter of the EPub e-book corresponding to the reading device, and upload the loading data of each chapter to the reading server; and
the reading server is further configured to: store the loading data of each chapter of the EPub e-book, which is uploaded by the reading device; receive an EPub e-book download request sent by another reading device, and check whether the loading data of each chapter of the EPub e-book is stored; and if the loading data of each chapter of the EPub e-book is stored, send the loading data of each chapter of the EPub e-book at the same time when sending the EPub e-book.

17. The system according to claim 16, wherein the loading data of each chapter of the EPub e-book comprises an identifier of the EPub e-book, directory index information of each chapter of the EPub e-book, page attributes effective at time of resolving each chapter, and number of pages of each chapter of the EPub e-book.
